(19) United States
(12) Patent Application Publication
(10) Pub. No.: US 2017/0161686 A1
(43) Pub. Date: Jun. 8, 2017

(54) SYSTEMS AND METHODS FOR MATCHING JOB SEEKERS AND JOB OPENINGS

(71) Applicant: Job-One v/Marianne Sihm Christiansen, Holte (DK)

(72) Inventor: René Bo Dyrvig, Odense C (DK)

(21) Appl. No.: 15/367,858

(22) Filed: Dec. 2, 2016

Related U.S. Application Data
(60) Provisional application No. 62/262,526, filed on Dec. 3, 2015.

(51) Int. Cl. G06Q 10/10; G06F 17/30

(52) U.S. Cl. CPC G06Q 10/1053; G06F 17/30386; G06F 17/30867; G06F 17/3053; G06F 17/30371

(57) ABSTRACT

The present disclosure relates to computer software. In particular, it relates to a technique for enhancing job search results for both job seekers looking for job openings and employer/recruiters looking for job seeker. The present disclosure therefore relates to a (computer implemented) method for selecting the most qualified job seekers for a job opening.

### CROSS-REFERENCE TO RELATED APPLICATION

The present application claims priority to U.S. Provisional Patent Application Ser. No. 62/262,526, filed Dec. 3, 2015 and entitled “SYSTEM AND METHOD FOR MATCHING JOB SEEKERS AND JOB OPENINGS,” the entire contents of which is incorporated herein by reference.

### BACKGROUND

Field

The present disclosure generally relates to systems and methods for selecting an appropriate job seeker for a particular job opening. More specifically, the systems and methods described herein relate to a technique for enhancing job search results for both job seekers looking for job openings and employer/recruiters looking for job seekers.

Technical Background

Companies seeking new employees may have difficulty filtering information to find the best suited applicants for a particular position. Similarly, job seekers seeking new job openings may also have difficulty filtering information to find the best suited positions for themselves. Currently, human resource departments may create a job description for each open position and may electronically advertise the position and the description. Job seekers may review and analyze these descriptions in order to determine whether a match exists between their desires, competences, and/or the like and particular jobs. With the advent of electronic job recruitment databases, it has also become possible for job seekers to advertise their resume and/or curriculum vitae (CV) in these electronic databases while searching for jobs.

A number of electronic/Internet-based searching tools are available to individuals that desire to search for jobs. For example, job seekers may electronically search for job openings based on factors such as distance from home, industry, and job title. However, the returned results list from such a search may be a cumbersome and large list that includes positions which still result in candidate disqualification due to various factors, such as, for example, lack of educational requirements, lack of skill set, and/or the like. As a result, certain electronic/Internet-based search tools may require the employer and/or the job seeker to sift through a large number of search results or can return no search results at all if the criteria provided are too specific or narrow.

Accordingly, a need exists for a tool that is specifically used for electronic-based and/or Internet-based searching that better and faster matches job seekers to potential job openings and matches job openings to potential job seekers.

### SUMMARY

In one embodiment, a method for selecting most qualified job seekers for a job opening, the most qualified job seekers selected among a plurality of job seekers having a personal profile stored in a database, the job opening associated with a group of desired attributes, each personal profile associated with a group of job seeker attributes selected by the corresponding job seeker, said group of job seeker attributes at least comprising personality attributes. The method includes a first personality filtering process, a second personality validation process, and a third confirmation process. The first personality filtering process includes calculating, by a processing device, a matching score for each job seeker for each job opening by matching the group of desired attributes of the job openings to the personal profiles of the job seekers and selecting, by the processing device, the most qualified job seekers based on the matching score. The second personality validation process includes generating, by the processing device, a personality related questionnaire based on one or more of the job opening attributes, the questionnaire having a text based part, and a video based part, providing, by the processing device, each of the qualified job seekers with said questionnaire, the text based part of the questionnaire having limited answering options, the video based part posing one or more questions to be answered by a video interview by the qualified job seekers, receiving, by the processing device, answers to the questionnaires from the qualified candidates, calculating, by the processing device, a validation score for each answering job seeker for each job opening by matching the group of desired attributes of the job openings to the text based questionnaire answers from the job seekers, and selecting, by the processing device, one or more most preferred qualified job seekers based on the validation score. The third confirmation process includes transmitting, by the processing device, the video interviews of the one or more most preferred qualified job seekers to an employer.

In another embodiment, a method for customizing a job opening in a database to a plurality of job seekers, one or more most qualified job seekers selected among a plurality of job seekers having a personal profile stored in the database, each personal profile associated with a group of job seeker attributes selected by a corresponding job seeker, said group of job seeker attributes at least comprising personality attributes. The method includes receiving, by a processing device, an association from a user, wherein the association associates a job opening to at least one desired attribute characterizing the job opening, calculating, by the processing device, a matching score for said job opening by matching the at least one desired attribute of the job opening to the personal profiles of the job seekers in the database, ranking, by the processing device, the job seekers based on the matching score and presenting the job seeker rank to the user, and repeating, by the processing device, the receiving, the calculating, and the ranking for at least one new desired job attribute and/or for at least one amended job attribute until a desired distribution in the ranking of job seekers is achieved, thereby customizing the job opening to the plurality of job seekers in the database.

In yet another embodiment, a system for selecting most qualified job seekers for a job opening, the most qualified job seekers selected among a plurality of job seekers having a personal profile stored in a database, the job opening associated with a group of desired attributes, each personal profile associated with a group of job seeker attributes selected by a corresponding job seeker, said group of job seeker attributes at least comprising personality attributes. The system includes a processing device component, input/output hardware, and network interface hardware. The processing device is configured to complete a first personality filtering process comprising calculating a matching score for each job seeker for each job opening by matching the group of desired attributes of the job openings to the personal profiles of the job seekers and selecting the most qualified job seekers based on the matching score and complete a second personality validation process comprising generating a personality related questionnaire based on one or more of the job opening attributes, the questionnaire having a text based part, and a video based part, calculating a validation score for each answering job seeker for each job opening by matching the group of desired attributes of the job openings to the text based questionnaire answers from the job seekers, and selecting, by the processing device, one or more most preferred qualified job seekers based on the validation score. The input/output hardware is configured to provide each of the qualified job seekers with said questionnaire, the text based part of the questionnaire having limited answering options, the video based part posing one or more questions to be answered by a video interview by the qualified job seekers and receive answers to the questionnaires from the qualified candidates. The network interface hardware is configured to complete a third confirmation process comprising transmitting the video interviews of the one or more most preferred qualified job seekers to an employer.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network for a system for matching job seekers and job openings according to one or more embodiments shown and described herein;

FIG. 2 schematically depicts the server computing device from FIG. 1, further illustrating hardware and software that may be used in matching job seekers and job openings according to one or more embodiments shown and described herein;

FIG. 3 depicts a flow diagram of an illustrative method of conducting a personality filtering process according to one or more embodiments shown and described herein;

FIG. 4 depicts a block diagram of various illustrative job seeker attributes that may contribute to a personal profile of a job seeker and which may be considered when calculating a matching score to a specific job opening according to one or more embodiments shown and described herein;

FIG. 5 depicts an illustrative user interface of various selectable personal interest attributes that may be selected by a job seeker when filling out a personal profile. according to one or more embodiments shown and described herein;

FIG. 6 depicts an illustrative user interface of various selectable experience attributes that may be selected by a job seeker when filling out a personal profile according to one or more embodiments shown and described herein;

FIG. 7 depicts a flow diagram of an illustrative method of conducting a personality validation process according to one or more embodiments shown and described herein; and

FIG. 8 depicts a flow diagram of an illustrative method of customizing a job opening in a database to a plurality of job seekers according to one or more embodiments shown and described herein.

### DETAILED DESCRIPTION

Referring generally to the figures, embodiments described herein are directed to systems and methods for helping job seekers discover appropriate job openings that are suited to their particular skills, needs, education, and/or the like by accurately determining characteristics from electronic data relating to the particular skills, needs, education, and/or the like and matching the characteristics from the electronic data to job opening data contained within electronic jobs databases.

Over half of all job openings can be referred to as entry level positions. The skills and experience within these job openings usually do not require much experience and more importance may therefore be applied to for example personality and interests of the job seeker. Therefore, a need exists for a tool that quickly and efficiently can match job seekers with job openings without requiring too much effort from either job seekers or employers. The present disclosure therefore in a first embodiment relates to a computer implemented method for selecting the most qualified job seekers for a job opening, the most qualified job seekers selected among a plurality of job seekers having a personal profile stored in a database, the job opening associated with a group of desired attributes, each personal profile associated with a group of job seeker attributes selected by the corresponding job seeker, said group of job seeker attributes at least comprising personality attributes. This first embodiment relates to the selection of the most qualified job seekers for a job opening. By means of electronic communication and computerized data handling, the speed of the selection process for a job opening can be significantly increased. The first filtering process can be instantly provided because the matching score can be calculated in real time and continuously updated. Hence, the initially most qualified job seekers can be enquired very fast with the questionnaire. The second personality filtering process is provided to make sure that the personality of the job seeker matches the desired attributes of the job opening. The questionnaire typically requires the job seeker to a further commitment, e.g., by taking a stand in various personality related issues, issues that are relevant for the specific job opening.

A second embodiment of the present disclosure relates to a computer implemented method for customizing a job opening in a database to a plurality of job seekers, the most qualified job seekers selected among a plurality of job seekers having a personal profile stored in the database, each personal profile associated with a group of job seeker attributes selected by the corresponding job seeker, said group of job seeker attributes at least comprising personality attributes. This second embodiment addresses the situation of an employer defining a job opening and the challenge of selecting the appropriate desired job attributes such that a suitable number of qualified job seekers are targeted. By constantly having access to the matching scores of the job seekers in the database, the employer can add, remove or amend the attributes of the job opening and see the matching scores of the most qualified job seekers in real time thereby customizing the job opening to the available job seekers.

The present disclosure further relates to a data-processing system, optionally comprising a processor and a memory and a database—or access to a database, the system being configured to perform the herein disclosed methods. Hence the presently disclosed methods may be executed in an App downloaded to a smartphone.

The present disclosure further relates to a computer readable medium having stored thereon instructions which, when executed by a computing device or system, cause the computing device or system to perform the presently disclosed methods.

The systems and methods described herein solve a problem that exists only within the realm of electronic/Internet based searching because the systems and methods interact with information that is only available electronically. For example, electronic data includes information regarding a particular applicant's personality (e.g., video clip data) which would not be present in non-electronic means (e.g., a paper resume/CV). Rather, to obtain information that is instantly available electronically, one would necessarily have to complete many more additional steps to obtain such information. For example, electronic data can contain information regarding the personality traits of a particular applicant (e.g., recorded video that is prepared by an applicant, and/or the like) that is easily evaluated electronically but would be difficult to obtain using non-electronic means, such as contacting the applicant, requesting and scheduling an interview, asking the applicant specific questions to determine various personality traits, and/or the like. Moreover, existing electronic search means currently do not account for this data in automatically determining whether a particular job seeker is suited for a particular open position. Rather, existing means would require human input/oversight, which would require a human to evaluate the personality data and provide an input relating to an evaluation. The present systems and methods eliminate such a need for human input/oversight.

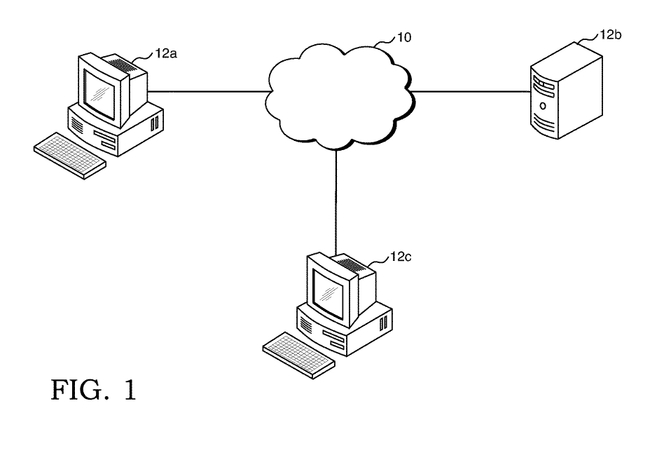

Referring now to the drawings, FIG. 1 depicts an illustrative computing network that depicts components for a system for matching job seekers and job openings according to embodiments shown and described herein. As illustrated in FIG. 1, a computer network 10 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 10 may generally be configured to electronically connect one or more computing devices and/or components thereof. Illustrative computing devices may include, but are not limited to, a user computing device 12a, a server computing device 12b, and an administrator computing device 12c.

The user computing device 12a may generally be used as an interface between a user and the other components connected to the computer network 10. Thus, the user computing device 12a may be used to perform one or more user-facing functions, such as receiving one or more inputs from a user or providing information to the user, as described in greater detail herein. Accordingly, the user computing device 12a may include at least a display and/or input hardware, as described in greater detail herein. In some embodiments, the user computing device 12a may be used by a job seeker. In other embodiments, the user computing device 12b may be used by an individual affiliated with a company, particularly a company having a job opening. For example, the user computing device 12b may be used by a member of the HR department of a company.

Additionally, included in FIG. 1 is the administrator computing device 12c. In the event that the server computing device 12b requires oversight, updating, or correction, the administrator computing device 12c may provide the desired oversight, updating, and/or correction. The administrator computing device 12c may also be used to input additional data into any corpus of data stored on the server computing device 12b, as described in greater detail herein.

The server computing device 12b may receive data from one or more sources, generate data, store data, index data, search data, and/or provide data to the user computing device 12a in the form of search results, video files, audio files, documents (e.g., resume/CV documents), document excerpts, questionnaires, questionnaire results, and/or the like.

It should be understood that while the user computing device 12a and the administrator computing device 12c are depicted as personal computers and the server computing device 12b is depicted as a server, these are nonlimiting examples. More specifically, in some embodiments, any type of computing device (e.g., mobile computing device, personal computer, server, etc.) may be used for any of these components. Additionally, while each of these computing devices is illustrated in FIG. 1 as a single piece of hardware, this is also merely an example. More specifically, each of the user computing device 12a, server computing device 12b, and administrator computing device 12c may represent a plurality of computers, servers, databases, components, and/or the like.

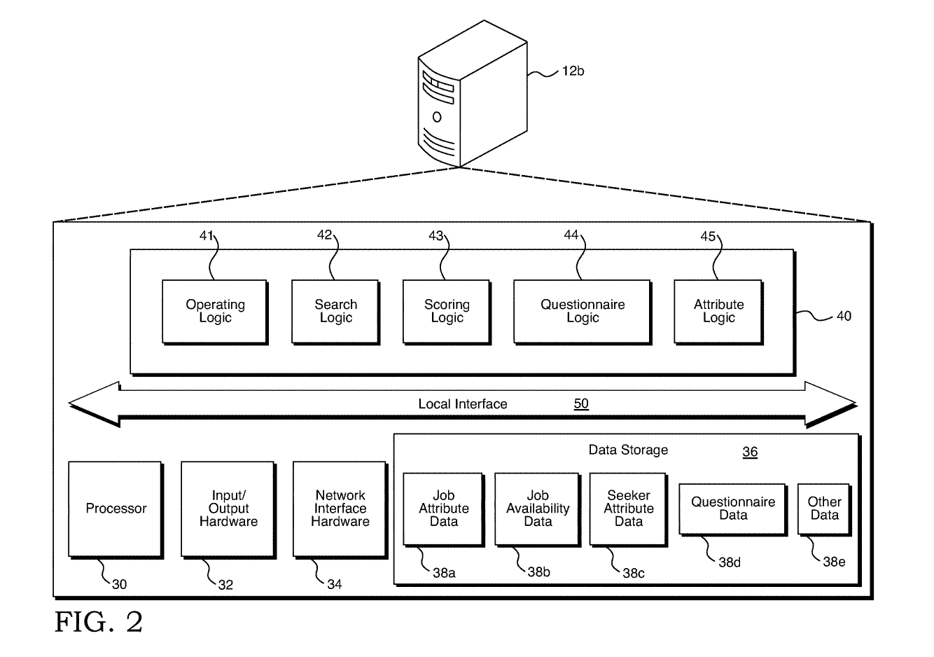

FIG. 2 depicts the server computing device 12b, from FIG. 1, further illustrating a system for receiving data from one or more sources, generating data, storing data, indexing data, searching data, and/or providing data, as described herein. In addition, the server computing device 12b may include a non-transitory computer-readable medium for searching and providing data embodied as hardware, software, and/or firmware, according to embodiments shown and described herein. The server computing device 12b may be configured as a special purpose computer designed specifically for performing the functionality described herein.

As illustrated in FIG. 2, the server computing device 12b may include a processing device 30, input/output hardware 32, network interface hardware 34, a data storage component 36 (which may store job attribute data 38a, job availability data 38b, job seeker attribute data 38c, questionnaire data 38d, and/or other data 38e), and a non-transitory memory component 40. The non-transitory memory component 40 may be configured as a volatile and/or a nonvolatile processor-readable medium and, as such, may include random access memory (including SRAM, DRAM, and/or other types of random access memory), flash memory, registers, compact discs (CD), digital versatile discs (DVD), Blu-ray discs, and/or other types of storage components. Additionally, the memory component 40 may be configured to store various processing logic, such as operating logic 41, search logic 42, scoring logic 43, questionnaire logic 44, and/or attribute logic 45 (each of which may be embodied as a computer program, firmware, or hardware, as an example). A local interface 50 is also included in FIG. 2 and may be implemented as a bus or other interface to facilitate communication among the components of the server computing device 12b.

The processing device 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the server computing device 12b and may be configured to store one or more pieces of data and selectively provide access to the one or more pieces of data. As illustrated in FIG. 2, the data storage component 36 may store job attribute data 38a, job availability data 38b, seeker attribute data 38c, questionnaire data 38d, and/or other data 38e, as described in greater detail herein.

Included in the memory component 40 are the operating logic 41, the search logic 42, the scoring logic 43, the questionnaire logic 44, and/or the attribute logic 45. The operating logic 41 may include an operating system and/or other software for managing components of the server computing device 12b. The search logic 42 may conduct one or more searches on behalf of a job seeker (e.g., search for job openings) and/or conduct one or more searches on behalf of a company/employer (e.g., search for candidates). The scoring logic 43 may score various attributes, traits, and/or the like of a job seeker or a job opening, which can be used for ranking particular job seekers or job openings. The questionnaire logic 44 may generate a questionnaire that is specific to a particular job opening and/or job seeker, and may further provide the questionnaire to a job seeker. The attribute logic 45 may determine various attributes, characteristics, traits, and/or the like for job seekers and/or job openings.

It should be understood that the components illustrated in FIG. 2 are merely illustrative and are not intended to limit the scope of this disclosure. More specifically, while the components in FIG. 2 are illustrated as residing within the server computing device 12b, this is a nonlimiting example. In some embodiments, one or more of the components may reside external to the server computing device 12b. Similarly, while FIG. 2 is directed to the server computing device 12b, other components such as the user computing device 12a and the administrator computing device 12c may include similar hardware, software, and/or firmware.

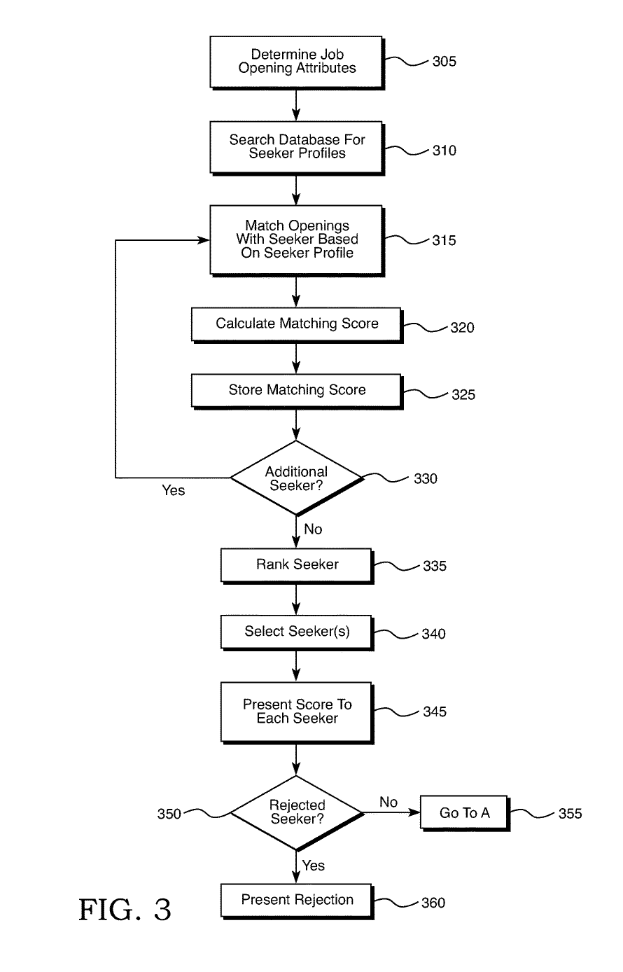

The various processes described herein generally relate to a method for selecting the most qualified job seekers for a job opening, where the most qualified job seekers are selected among a plurality of job seekers having a personal profile stored in a database, the job opening is associated with a group of desired attributes, each personal profile is associated with a group of job seeker attributes selected by the corresponding job seeker, and the group of job seeker attributes at least partially includes personality attributes. The various processes described herein may also generally relate to a method for customizing a job opening in a database to a plurality of job seekers, where the most qualified job seekers are selected among a plurality of job seekers having a personal profile stored in the database, each personal profile is associated with a group of job seeker attributes selected by the corresponding job seeker, and the group of job seeker attributes at least partially includes personality attributes. An illustrative personality filtering process that is part of the method for selecting the most qualified job seekers is depicted in FIG. 3.

The personality filtering process includes the step of preference ranking the job seekers based on their matching scores and/or validation scores. Hence, towards the employers the job seekers can be preference ranked and presented, e.g., the top 10, top 20, or top 100 highest matching scores are presented.

Similarly, the job openings in the database can be preference ranked towards the job seekers based on the matching score and/or the validation score, such that job seekers can see which job openings are most suitable, e.g., the top 10, top 20, or top 100 highest matching scores are presented. Consequently, the job seekers can customize their personal profile by adding, deleting, and/or amending the various job seeker attributes and see the resulting matching scores towards various job openings, substantially in real time.

In a further embodiment, rejection information is automatically forwarded to the unqualified job seekers in the first personality filtering process, the second personality validation process (as described hereinbelow), and/or the third confirmation process (as described hereinbelow), rejection information such as electronic communication, such as text message, email message, pop-up message, etc. This is to optimize and automate the filtering process of officially rejecting job seekers actively applying for a job opening.

In many job positions, the personality of the employee may be the most important parameter for a successful employment. The presently disclosed method addresses this issue by having at least two filtering processes for checking and verifying the personality of the job seekers. Additionally, the personality attributes of the job seekers may account for at least 30%, at least 40%, or at least 50% of the maximum achievable matching score.

In a further embodiment, a job opening can be associated with a timeline or one or more deadlines such that job seekers must complete one or more predefined tasks within one or more limited time periods, such as completing the first and/or the second filtering processes. The timeline/deadlines may be determined by the employer when creating the job opening in the database.

In a further embodiment, a specific job title, such as a specific job title in a specific industry, is associated with a specific questionnaire, such as the text based part of the questionnaire is predefined and associated with one or more job titles. Some job titles require certain personality skills and preferences. When screening for a specific job title, it is therefore advantageous to have a number of predefined personality related questions in the questionnaire that corresponds to the most important personality skills of said specific job title. By text based questionnaire is meant a questionnaire where at least the answers are text based, i.e., the questions that are presented to the job seekers can be answered in writing and/or by selecting between answers in a predefined list of answers, e.g., multiple choice style. By video based questionnaire is meant a questionnaire where at least the answers are provided by having the job seekers recording answers to the questions by means of video, e.g., by means of the video functionality in any smartphone, i.e., short video clips of the job seekers answering questions of the video based part of the questionnaire may be forwarded from the job seekers after video recording and stored in the database.

In a further embodiment, the questionnaire corresponding to a job opening is customizable by a user, such as an employer. It may be the text based part and/or the video based part that is customizable. However, in one preferred embodiment the text based part is predefined and corresponds to the job title and the video based part is customizable, e.g., an employer can select a number of questions from a predefined list and/or generate its own questions, for the job seekers to answer by video interview.

When a job opening is created in the database by an employer and “activated” the job matching score can be calculated instantly, i.e., the most qualified job seekers can instantly be notified about said job opening, e.g., by text message, pop-up, etc. This notification may enquire job seekers to answer the questionnaire within a predefined deadline. A major advantage of the presently disclosed method and system is the speed and precision that is possible to achieve when a vacant job opening is to be filled by a job seeker. Once a job opening is created in the database the employer does not have to sift manually through numerous applications. The first filtering process may be automatic and can be provided in real time during customization of the job opening. The second filtration process can therefore begin instantly, e.g., by notifying the job qualified job seekers enquiring them to answer the questionnaire. Once the answers are received the validation score can be calculated for the answering job seekers and the second personality validation process can be completed. In the third phase the video based part of the questionnaire from the job seekers having the highest validation score in the second filtering process is forwarded to the employers for review. An employer creating a job opening in the database can thereby very quickly end up with a limited and manageable number of short video interviews with the most preferred qualified job seekers that have been selected through the two filtering processes. Hence, the employer knows that the job seekers selected through the two filtering processes have the desired qualifications for the job opening and the last selection can at least partly be based on the short video interviews. The advantage for the employer is therefore that filtering of the job seekers for a job opening is provided by the presently disclosed method and system without attendance of the employer, i.e., the employer does not have to spend time on the primary and secondary sorting of job seekers for a job opening. Correspondingly, the job seekers can very quickly get an overview of the most relevant job openings in the database and the application process for a job opening requires very little work for a job seeker once a personal profile is created in the database. The presently disclosed systems and methods therefore meet the need resulting from the high turnover of staff that employers face and job seekers turn to and realize in some industries, especially in entry level or low-wage job positions.

In a further embodiment, the most qualified job seekers that are selected in the first personality filtering process and/or the second personality validation process may be selected according to one or more predefined limits/thresholds. One limit may be the matching score or the validation score, i.e., all job seekers having a score above a predefined limit, are selected in the first filtering process. It may also be defined that only a predefined number of job seekers are selected, i.e., the 20, 50, or 100 having the highest matching scores.

As stated elsewhere, the employer may be able to see the matching scores of job seekers in the database when creating the job opening such that the job opening attributes can be customized to target a suitable number of qualified job seekers. To make it more clear to the employer, the qualified job seekers that are found to be above a predefined score, e.g., at least 90 of a possible 100 points, may be collectively listed by score rank. For example, after customizing a job opening, the employer can see how many job seekers that have a score between 80 and 90, how many candidates that have a score between 90 and 100, and how many job seekers that have a score of 100. This helps the employer specify the needs more effectively, while keeping all the candidates relevant all the time.

In a further embodiment, various job title attributes, such as education, experience and personality, have different significance and importance. Hence, it may be advantageous to be able to associate different significance to different job title attributes and/or different groups of job title attributes, when calculating the job matching score. Significance may be applied in the form of preference ranking the attributes within a group of attributes and/or by preference ranking the groups of attributes, e.g., by associating one or more weight factors. One or more weight factors may be associated with specific job titles. Weight factors may also be selected by employers when creating a job opening. A weight factor may be applied to a sub-score of one or more of the group of job seeker attributes. A weight factor can also be indirectly applied when selecting how much of the matching score an attribute or a group of attributes can maximally account for.

FIGS. 3, 7, and 8 provide additional detail regarding the various processes that are completed by a processing device according to the embodiments described herein. Referring now to FIG. 3, various portions of the server computing device 12b depicted in FIG. 2 may be used to complete the various processes described herein with respect to FIG. 3, including, but not limited to, the operating logic 41, the search logic 42, the scoring logic 43, and/or the attribute logic 45. In addition, data may be accessed and/or stored in various portions of the data storage component 36, including, but not limited to, the job attribute data 38a, job availability data 38b, and/or seeker attribute data 38c.

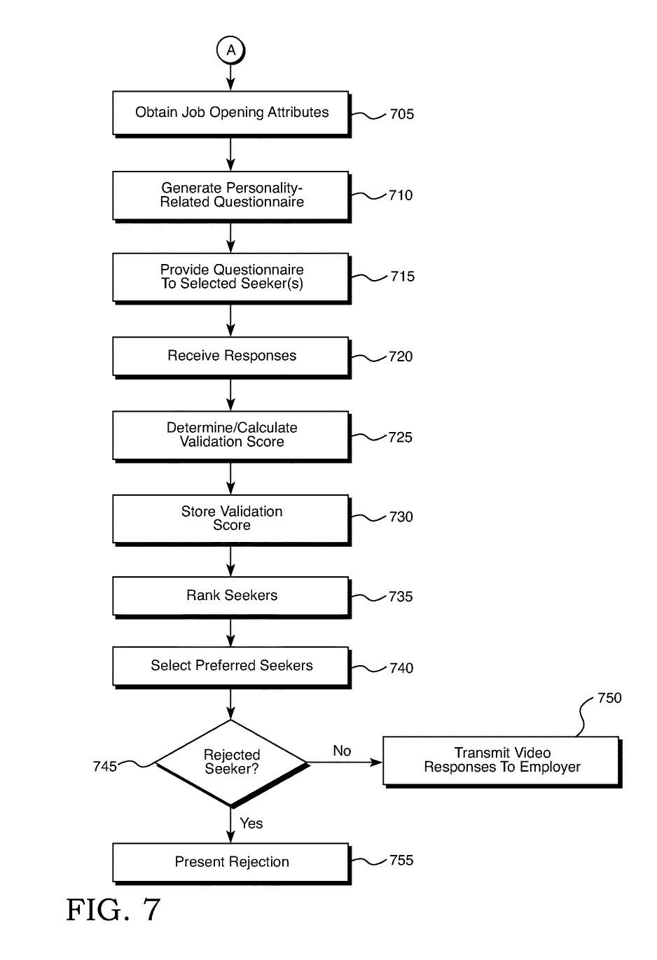

The personality filtering process includes the steps of determining job opening attributes at step 305, searching a database for seeker profiles at step 310, matching openings with each seeker based on the seeker's profile at step 315, calculating a matching score at step 320 and storing the matching score at step 325, determining whether additional seekers exist at step 330 (e.g., for lists of multiple seekers), and, if so, repeating the process at step 315. Once all of the job seekers have been scored, each seeker may be ranked at step 335 and one or more seekers may be selected at step 340. A score may be presented to each seeker at 345, and if the seeker is a rejected seeker (e.g., according to the determination at step 350), a rejection may be presented to the seeker at step 360. Otherwise, the process may continue to step A in FIG. 7 at step 355.

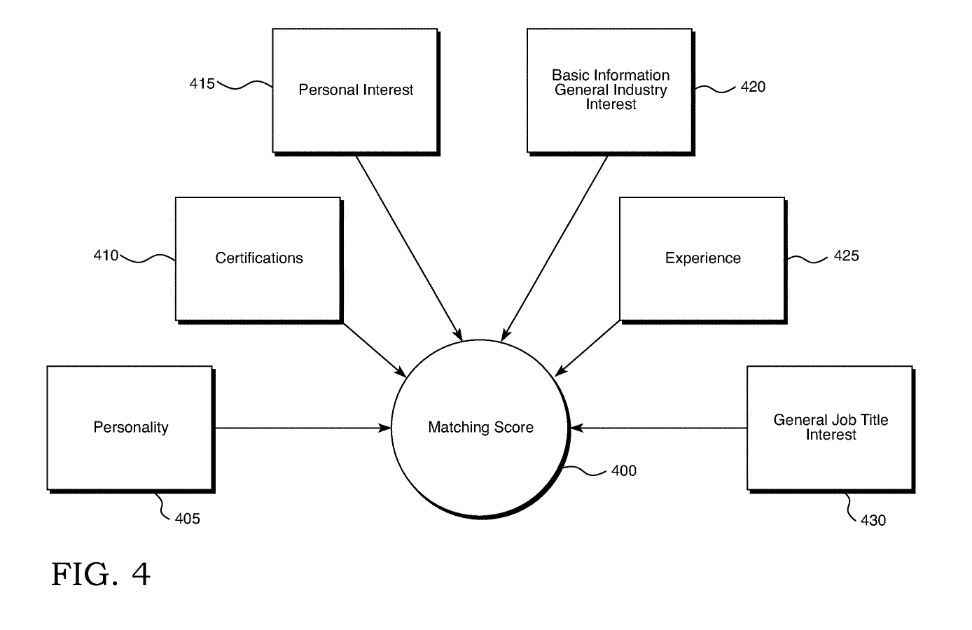

FIG. 4 depicts the various job seeker attributes that may be used when calculating a matching score 400. Attributes in a group of job seeker attributes may be selected from one or more predefined lists of attributes within said group. The number of selectable attributes for a job seeker may be limited to a predefined maximum number of attributes less than the total number of attributes in one or more of the groups of job seeker attributes. For example, if a total of twenty personality attributes are listed for a job seeker when creating a personal profile, a maximum number of only five or ten of these can be selected. Further, job seekers may be able to preference rank their attributes in their personal profile, such as preference rank their personality attributes.

In the first phase described above with respect to FIG. 3, the job matching score is calculated based on a plurality of predefined job seeker attributes that are stored in each job seeker profile and are the results of each job seeker entering information into a database. Illustrative examples of such job seeker attributes may include personality 405, official certifications 410, personal interests 415, basic information and industry general interest 420, experience from resume 425, and general job title interest 430.

One job seeker attribute can be personality 405. In one embodiment, job seekers can select personality attributes within their personal profile, such as from one or more predefined lists of personality attributes. Examples of personality attributes are “helping”, “calm”, “positive”, “spacy”, “reliable”, “ethical”, and “organized”, “decisive”, “numerical”, “communicative”, “detail-oriented”, “timely”, “mechanical”, handy“, outdoorsy”, and “ideas”. In a particular embodiment, a job seeker can only select and associate a limited number of personality attributes to their personal profile, e.g., maximum three, four, five, six, or seven personality attributes. A sub-score is applied based on the personality attributes that are desired by the employer and/or specified in the job opening and is aggregated as one of the attributes within the accumulative score. One or more or each of the personality attributes may be associated with a weight factor. This weight factor(s) may be selected by the employer when creating the job opening. The weight factor(s) may also be associated with predefined job titles, e.g., as a sales representative it is necessary to be persuasive, hence such a personality attribute may be associated with a high weight factor for a job opening as a sales representative.

Another job seeker attribute can be official certifications 410. In one embodiment, job seekers can select experience, for example, related to trade certification and education, within their personal profile, such as from one or more predefined lists of certifications and educations and educational degrees. In some industries, possible and/or required certifications/educational requirements are required and/or standard and may be included here in the predefined list. Examples are accounting, building construction, physical therapy, veterinary technician, etc. Examples of educational degrees are high school, bachelor's degree, etc. If a match exists between the job opening and the certification, a sub-score is applied and is aggregated as one of the attributes within the accumulative score.

Another job seeker attribute can be personal interests 415. Hence, in one embodiment, job seekers can select personal interests, such as from a predefined list of personal interests. For instance, an employer that is looking for a mechanic would possibly like to hire employees with a genuine interest in cars. This permits both job seekers and employers to match with personal characteristics that improve the long term success of employee engagement and reduce staff turnover. If a match is detected between the job opening and the personal interest(s) selected by the job seeker in his personal profile a sub-score is applied and is aggregated as one of the attributes within the accumulative score.

Another job seeker attribute can be basic information and industry general interest 420. Basic information regarding the job seeker may include, for example, birthday, home address, geographical range of interest, i.e., which geographical area are relevant, age, seasonal and time availability, i.e., at what time of the year, the months, the week and/or the time of the day are the job seeker available and willing to work. Another type of basic information is desired salary. This type of basic information may be selected from predefined lists and stored in the personal profile. A sub-score may be applied and can be aggregated as one of the attributes within the accumulative score. However, basic information may also be the subject of rejection filtering, e.g., job openings seeking people more than the age of 21 are not relevant for job seekers below the age of 21, e.g., if the job opening involves handling of alcoholic beverages. Hence, job seekers may be rejected for a specific job opening based on such attributes even if their job matching score would qualify them for passing the first or second filtering processes. Industry preference/general interest may include, for example, one or more preferences towards industry segment. Hence, in one embodiment job seekers can select industry preference, such as from a predefined list of business segments, for example, accounting, administration, automotive, etc. This permits both candidates and employers to match with personal characteristics that improve the long term success of employee engagement and reduce staff turnover. If a match is detected between the job opening and the industry preference, a sub score is applied and is aggregated as one of the attributes within the accumulative score.

Another job seeker attribute can be experience 425, i.e., actual job experience. Hence, in one embodiment, job seekers can type in period of experience, such as from a predefined list of specific job categories and titles, and store it in the personal profile. If a match is detected between the job opening and the experience(s) listed by the job seeker, a sub score is applied and is aggregated as one of the attributes within the accumulative score.

Another job seeker attribute can be general job title interest 430, i.e., job titles and/or job categories that are of particular interest to the job seeker, in order to identify job titles/categories that are of interest to the job seeker, for example food service, customer service, retail sales, etc. Hence, in one embodiment, job seekers can select general job title interests, such as from a predefined list of job titles and job categories, and store it in the personal profile. When a match is detected between the job opening and the candidates “General Job Title Interest” a sub score is applied and is aggregated as one of the attributes within the accumulative score.

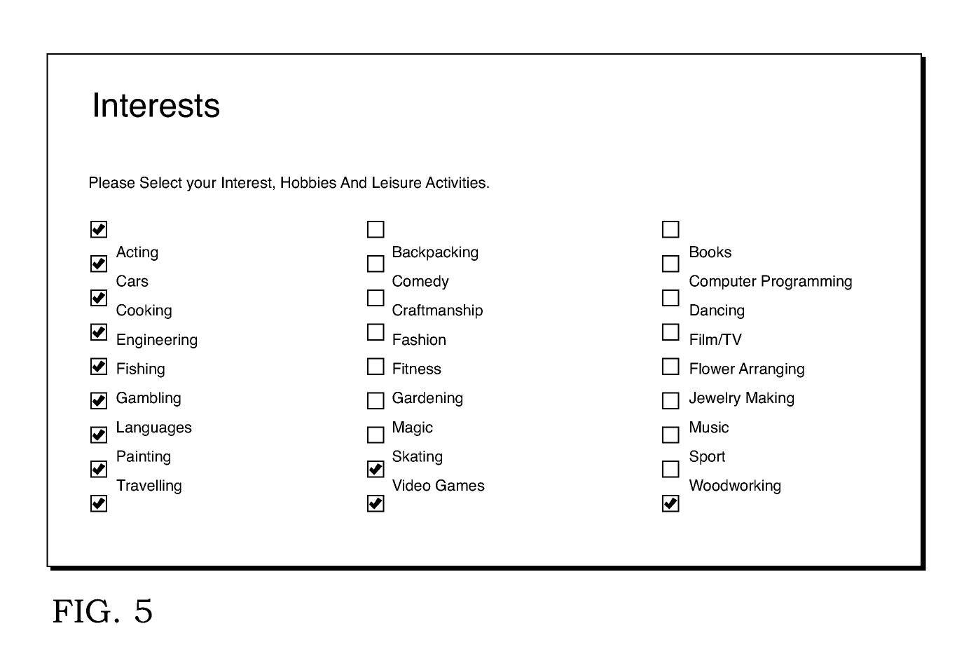

FIG. 5 depicts an illustrative user interface screen where a user can select one or more interests. As seen in FIG. 5, there are 27 selectable personal interests in total, but in this case the user is only allowed to select maximum 12 personal interests of these 27 interests in total. The maximum selectable number can be predefined by an administrator or employer. Typically, the maximum selectable number of attributes for groups of attributes such as personal interests and personality are more limited to more narrowly characterize the job seeker, e.g., limited to less than 8, 7, 6, e.g., limited to maximum 5 attributes in a group of attributes.

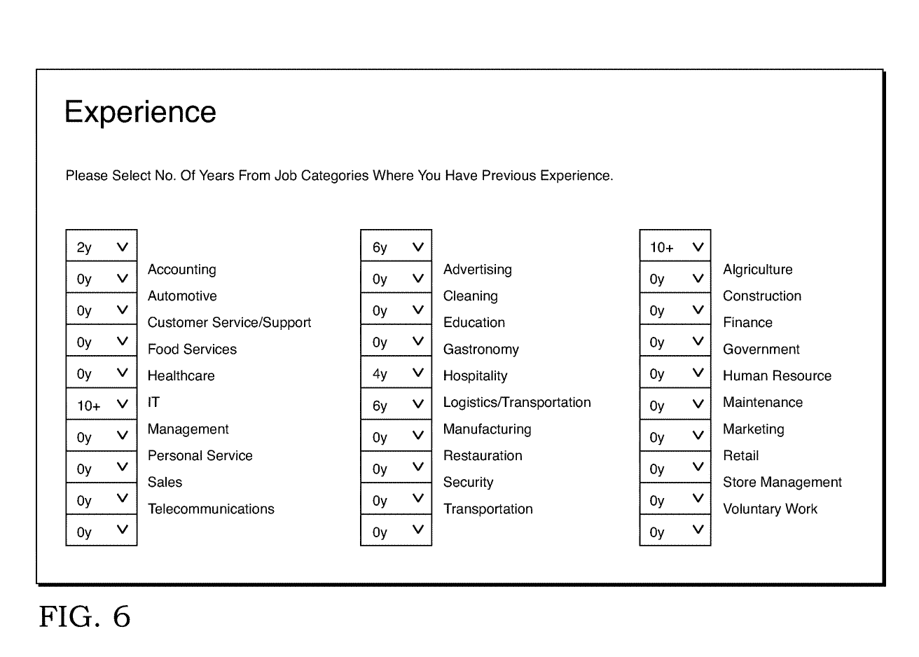

Similarly, FIG. 6 depicts an illustrative user interface screen where a user can select experience. As seen in FIG. 6, a job seeker can select numbers of years of experience attained in various industries.

Referring now to FIG. 7, the various processes for conducting a personality validation as described herein are depicted. The processes described herein with respect to FIG. 7 may utilize various portions of the server computing device 12b depicted in FIG. 2, including, but not limited to, the operating logic 41, the scoring logic 43, the questionnaire logic 44, and/or the attribute logic 45. In addition, data may be accessed and/or stored in various portions of the data storage component 36, including, but not limited to, the job attribute data 38a, job availability data 38b, seeker attribute data 38c, and/or the questionnaire data 38d. The processes may include, for example, obtaining job opening attributes at step 705, generating a personality-related questionnaire at step 710, providing the questionnaire to one or more selected job seekers at step 715, receiving responses to the questionnaire at step 720, determining/calculating a validation score at step 725, storing the determined/calculated score at step 730, ranking the seekers according to validation scores at step 735, and selecting a preferred number of seekers from the ranked list of seekers at step 740. In addition, the process may include determining at step 745 if the seeker has been rejected (i.e., not selected according to step 740), and, if so, presenting the rejection to the seeker at step 755. If the seeker is one of the preferred seekers that was selected according to step 740, the video responses generated for the seeker may be transmitted to the employer at step 750.

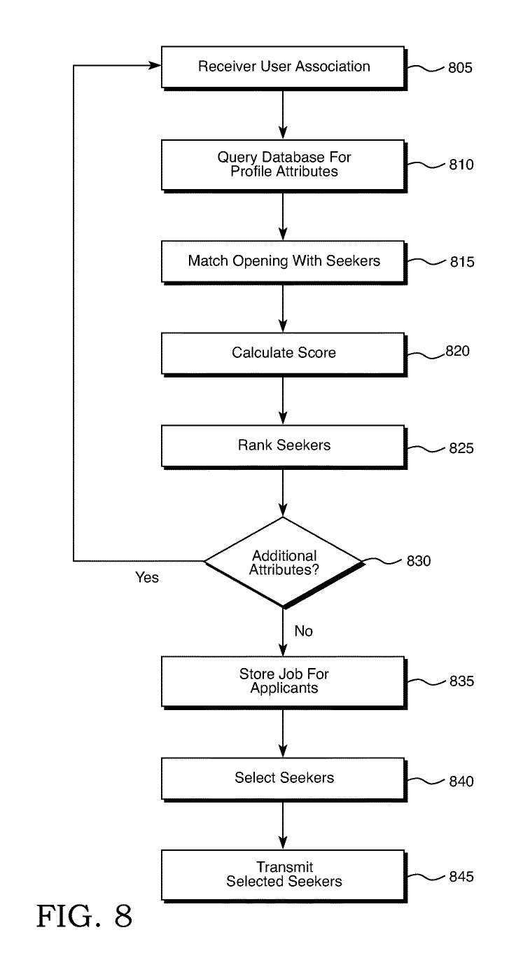

Referring now to FIG. 8, the various processes for customizing a job opening in a database as described herein are depicted. The processes described herein with respect to FIG. 8 may utilize various portions of the server computing device 12b depicted in FIG. 2, including, but not limited to, the operating logic 41, the search logic 42, the scoring logic 43, and/or the attribute logic 45. In addition, data may be accessed and/or stored in various portions of the data storage component 36, including, but not limited to, the job attribute data 38a, job availability data 38b, seeker attribute data 38c, and/or the other data 38d. The processes may include, for example, receiving user associations at step 805, querying a database for profile attributes at step 810, matching a job opening with seekers having matching profile attributes at step 815, calculating a score therefrom at step 820, ranking the seekers at step 825, determining whether additional attributes for the job exist at step 830 (and if so, repeating steps 805-825 for each attribute), storing the job for applicants at step 835, selecting seekers at step 840, and transmitting the selected seekers to an employer at step 845.

### Example

A job opening entered into the database by an employer is associated with a job title or job category and a company—and thereby an association with one or more industries or industry segments. Hence, a new job opening may be initially classified with a job title and (at least one) industry segment. The presently disclosed method and system can then select a standard set of attributes for the job opening based on the initially selected job title and industry. These attributes may be selected from the list of duties, knowledge, education, and interests, cf. Table 1.

TABLE 1

| Job Category | | Knowledge, | Education/ | |
|---|---|---|---|---|
| (Sample) | Duties | Experience, Abilities | Training | Interests/Personal |
| Warehouse & | Perform physical activities | Able to lift, push, pull, | High school diploma | Reliable and |
| Production | that require constantly | or carry objects and/or | or GED | dependable |
| Laborers and | using hands, arms, feet and | move quickly | | Careful about detail |
| Freight Handler, | legs to balance, and walk, | Able to do physically- | | Like to work with |
| Stock, and | in order to life and carry | demanding work | | others rather than alone |
| Material Movers, | objects. | without getting tired | | Able to depend on self |
| Hand, Materials | Operate machines or | Good Vision - The | | to get things done |
| Handler | vehicles. | ability to see | | Enjoy seeing the |
| | Speak often with | Able to listen, to | | progress you are |
| | supervisors and team | understand and share | | making |
| | members in order to make | information in a | | Willing to follow rules |
| | sure work is done correctly | conversation | | and procedures |
| | and safely. | Able to read and | | |
| | | understand written | | |
| | | information | | |
| Legal Assistant | Assist lawyers by | Knowledge of legal | High school diploma | Attentive to detail |
| Certified Paralegal, | investigating facts, | procedures | or GED | Cooperation - being |
| Immigration | preparing legal documents, | Ability to use a | Training in | pleasant with others on |
| Paralegal, Law | or researching legal | computer to perform | vocational schools, | the job and displaying |
| Clerk, Legal | precedent. Conduct | office tasks such as | related on-the-job | a good-natured, |
| Analyst, Legal | research to support a legal | email, copying, faxing | experience, or an | cooperative attitude. |
| Assistant, Legal | proceeding, to formulate a | Strong organizational | associate's degree. | Dependability - being |
| Clerk, Paralegal, | defense, or to initiate legal | skills | One or two years of | reliable, responsible, |
| Paralegal | action. | Strong written | training involving | and dependable, |
| Specialist, Real | Prepare legal documents | communication skills | both on-the-job | Integrity - being |
| Estate Paralegal, | and correspondence, and | Ability to deal directly | experience and | honest and ethical. |
| Summer Law | organize and maintain | with the public | informal training | Initiative - willing to |
| Associate | documents in paper or | | with experienced | take on responsibilities |
| | electronic filing system. | | workers. | and challenges. |
| | Prepare for trial by | | | |
| | performing tasks such as | | | |
| | organizing exhibits. | | | |
| | Prepare legal documents, | | | |
| | including briefs, pleadings, | | | |
| | appeals, wills, contracts, | | | |
| | and real estate closing | | | |
| | statements. | | | |
| | Meet with clients and other | | | |
| | professionals to discuss | | | |
| | details of case. | | | |
| | File legal documents with | | | |
| | court clerk. | | | |

Hence, each job opening can be pre-characterized such that the system knows which competences to search for. This pre-characterization can result in that each job opening is associated with a list of desired personal attributes for the job seekers.

TABLE 2

| | | Ranking of |
|---|---|---|
| Job | | Personality |
| Titles & Key Words | Personality attributes | attributes |
| Laborers and | SOCIAL | 9 |
| Freight Handler, | | |
| Stock and Material | | |
| Movers, Materials | | |
| Handler, Warehouse | | |
| Manufacturer | SPACY | 4 |
| Manufacturing | RELIABLE | 8 |
| Assembly | ORGANIZED | 10 |
| | COMMUNICATIVE - SPEAKING | 6 |
| | DETAIL-ORIENTED | 7 |
| | TIMELY | 3 |
| | MECHANICAL | 5 |
| | HANDY | 1 |
| | OUTDOORSY | 2 |

Table 2 shows an exemplary list of desired personality attributes for the job openings listed in the left column. The personal attributes are ranked after importance/priority in column 3. The system and method thereby knows that within “Manufacturing” it is important to be handy, timely and outdoorsy. In one embodiment this personality attribute is the most important attribute and may be more than 30%, more than 40%, or at least 50% of the total score.

### First Phase

For an employer the first step when creating a job opening is therefore to select a job title and corresponding industry (segment). If the employer is known by the system the industry may be associated with the name of the employer, e.g., company name. An accumulated score can then be calculated for each job seeker to provide the matching score for a specific job opening. The employer might also select one or more deadlines for the various phases to be completed by the job seekers, i.e., a timeline can be selected. In one embodiment, all job seekers having at least a predefined accumulated score, e.g., at least 70%, at least 80%, or at least 90%, are allowed to enter the second phase.

### Second Phase

In one embodiment the purpose of the second phase is to validate the attributes of the remaining job seekers. Initially (i.e., in the first phase) the employer can also define the questionnaire, e.g., by selecting a number of questions, e.g., personality related questions, for the job seekers in the second phase to answer in the questionnaire. These questions can be selected from various lists of predefined questions. A number of questions may be suggested to the employer based on the job title and industry of the job opening. The employer may also select questions for the candidates to answer in video interviews.

The validation score may be attributed to the personality of a job seeker by having the job seekers answering questions in the questionnaire in the second phase, e.g., within a scale of 0 to 100, regarding their affinity for specific personality related activities, e.g., within a scale of 0 to 100, of how much they lean towards the right or the left of two questions, as exemplified in table 1.

TABLE 3

| | | A lot | Sometimes | A lot | |
|---|---|---|---|---|---|
| PERSONALITY | Questions for Candidates | J | K | J | Questions for Candidates |
| SOCIAL | I like to be around other people | 100 | | 0 | I like to work alone |
| | when I work | | | | |
| HELPING | I like dealing directly with | 100 | | 0 | Customers can really stress me out. |
| | customers/clients/guests/patients in | | | | I like dealing only with coworkers |
| | my job | | | | and not with |
| | | | | | customers/clients/guests/patients |
| PERSUASIVE | I can get other people to see things | 100 | | 0 | I don't like trying to influence |
| | my way (e.g., influencing them to | | | | people; I would not enjoy selling or |
| | buy something from me) | | | | helping customers/clients/guests to |
| | | | | | see things a certain way |
| CALM | I can keep my emotions in check | 100 | | 0 | I get annoyed easily; people say I |
| | when dealing with difficult | | | | am unpredictable |
| | situations. | | | | |
| POSITIVE | I believe that things will work out | 100 | | 0 | Bad things tend to happen, in my |
| | for the best | | | | experience |
| SPACY | If I have to work in a small space | 0 | | 100 | I don't mind working in small |
| | (e.g., an enclosed booth, crawling | | | | spaces (e.g., an enclosed booth, |
| | into a tunnel) I would be very | | | | crawling into a tunnel) |
| | unhappy | | | | |
| RELIABLE | People can count on me to get | 100 | | 0 | I sometimes forgot to follow |
| | things done | | | | through on things I said I would do; |
| | | | | | I am not always dependable |
| ETHICAL | I do whatever it takes - there is no | 0 | | 100 | I try to do the right thing |
| | such thing as “the right thing” | | | | |
| ORGANTZED | I am organized and like to organize | 100 | | 0 | I find the things I need when I need |
| | things; I like following procedures | | | | them but I don't really have a |
| | | | | | system; I don't like following |
| | | | | | procedures |
| DECISIVE | I am comfortable making decisions | 100 | | 0 | I do not like to make decisions and |
| | and taking responsibility for making | | | | prefer not to be in the “hot seat” |
| | decisions | | | | |
| NUMERICAL | I don't like to work much with | 0 | | 100 | I like to work with numbers & |
| | numbers and calculations | | | | calculations |
| COMMUNICATIVE - | I like to communicate in writing | 100 | | 0 | I don't like to write or read |
| WRITING | | | | | |
| COMMUNICATIVE - | I like to communicate by speaking | 100 | | 0 | I don't like to talk much and I am |
| SPEAKING | | | | | not a good listener either |
| DETAIL-ORIENTED | I am good with details - I like lists | 100 | | 0 | I don't like details - they bore me; I |
| | and am good at making sure nothing | | | | like to think about the big picture |
| | gets missed | | | | |
| INDEPENDENT | I like it when my supervisor tells me | 0 | | 100 | I like to have some freedom to make |
| | exactly what to do and how to do it | | | | decisions about how to do my job |
| TIMELY | I like the challenge of having to get | 100 | | 0 | Deadlines stress me out; I like to |
| | things done by a deadline | | | | have a lot of time to get my work |
| | | | | | done |
| MECHANICAL | I avoid mechanical things; I don't | 0 | | 100 | I like to work with mechanical |
| | like using things like electric | | | | things (e.g., engines, electrical) |
| | screwdrivers | | | | |
| HANDY | I like working with my hands | 100 | | 0 | I don't like to get my hands dirty |
| | | | | | when I work |
| OUTDOORSY | I like working outdoors | 100 | | 0 | I like working in an office |
| IDEAS | I like working with ideas | 100 | | 0 | I like working with things |

In table 3, each question listed in columns 2 and 6 are associated with a personality attribute in column 1. However, in the questionnaire provided to the job seekers in the second validation filtering process, the job seekers may only see the questions, i.e., the job seekers cannot see which personality attribute with which the questions are associated. The validation score of a job seeker for a specific job opening can be calculated based on how the job seekers answer these questions in relation to the desired job opening personality attributes. For example, for an accountant it is important that they are “numerical”, i.e., to obtain a high validation score they must lean 100% towards that they “like to work with numbers & calculations”, as exemplified in table 3 above.

It should now be understood that the systems and methods described herein can assist job seekers in discovering appropriate job openings that are suited to their particular skills, needs, education, and/or the like by accurately determining characteristics from electronic data relating to the particular skills, needs, education, and/or the like and matching the characteristics from the electronic data to job opening data contained within electronic jobs databases.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for selecting most qualified job seekers for a job opening, the most qualified job seekers selected among a plurality of job seekers having a personal profile stored in a database, the job opening associated with a group of desired attributes, each personal profile associated with a group of job seeker attributes selected by a corresponding job seeker, said group of job seeker attributes at least comprising personality attributes, the method comprising:
a first personality filtering process comprising:
calculating, by a processing device, a matching score for each job seeker for each job opening by matching the group of desired attributes of the job opening to the personal profile of the job seekers, and
selecting, by the processing device, the most qualified job seekers based on the matching score;
a second personality validation process comprising:
generating, by the processing device, a personality related questionnaire based on one or more of the desired attributes of the job opening, the questionnaire having a text based part, and a video based part,
providing, by the processing device, each of the qualified job seekers with said questionnaire, the text based part of the questionnaire having limited answering options, the video based part posing one or more questions to be answered by a video interview by the qualified job seekers,
receiving, by the processing device, answers to the questionnaires from the qualified job seekers,
calculating, by the processing device, a validation score for each answering job seeker for each job opening by matching the group of desired attributes of the job openings to the text based questionnaire answers from the job seekers, and
selecting, by the processing device, one or more most preferred qualified job seekers based on the validation score; and
a third confirmation process comprising:
transmitting, by the processing device, the video interview of the one or more most preferred qualified job seekers to an employer.

2. The method of claim 1, wherein the first personality filtering process further comprises preference ranking the job seekers based on their matching score.

3. The method of claim 1, further comprising presenting one or more of the matching score and the validation score of a job opening to the job seekers.

4. The method of claim 1, wherein the second personality validation process further comprises preference ranking the job seekers based on their validation score.

5. The method of claim 1, wherein rejection information is automatically forwarded to unqualified job seekers in one or more of the first personality filtering process, the second personality validation process, and the third confirmation process, wherein the rejection information comprises electronic communication.

6. A method for customizing a job opening in a database to a plurality of job seekers, one or more most qualified job seekers selected among a plurality of job seekers having a personal profile stored in the database, each personal profile associated with a group of job seeker attributes selected by a corresponding job seeker, said group of job seeker attributes at least comprising personality attributes, the method comprising:
receiving, by a processing device, an association from a user, wherein the association associates a job opening to at least one desired attribute characterizing the job opening;
calculating, by the processing device, a matching score for said job opening by matching the at least one desired attribute of the job opening to the personal profiles of the job seekers in the database;
ranking, by the processing device, the job seekers based on the matching score and presenting a job seeker rank to the user, and
repeating, by the processing device, the receiving, the calculating, and the ranking for at least one new desired job attribute and/or for at least one amended job attribute until a desired distribution in the ranking of job seekers is achieved, thereby customizing the job opening to the plurality of job seekers in the database.

7. The method of claim 6, further comprising at least one of storing and activating the job opening in the database such that the most qualified job seekers can apply for the job opening.

8. The method of claim 6, further comprising at least one of selecting and querying the most qualified job seekers for the job opening.

9. The method of claim 6, wherein the personality attributes of the job seekers account for at least 30% of a maximum achievable matching score.

10. The method of claim 6, wherein the group of job seeker attributes are selected from personality attributes, certifications, personal interests, basic information, industry preference and job title interest.

11. The method of claim 6, wherein attributes in the group of job seeker attributes are selected from one or more predefined lists of attributes within the group of job seeker attributes.

12. The method of claim 6, wherein a number of selectable attributes for a job seeker is limited to a predefined maximum number of attributes less than the total number of attributes in one or more of the group of job seeker attributes.

13. The method of claim 6, wherein a job seeker can preference rank their attributes in a personal profile associated with the job seeker.

14. The method of claim 6, wherein employers can preference rank one or more desired job attributes in a job opening.

15. The method of claim 6, wherein employers can preference rank one or more of the groups of desired job attributes in a job opening.

16. The method of claim 6, wherein a job opening is associated with a timeline or one or more deadlines such that job seekers must complete one or more predefined tasks within one or more limited time periods.

17. The method of claim 6, wherein a particular job title is associated with a particular questionnaire.

18. The method of claim 6, wherein a questionnaire is customizable by a user.

19. The method of claim 6, wherein a job opening is presented to the most qualified job seekers upon activation of said job opening, wherein said qualified job seekers are enquired to answer the questionnaire within a predefined deadline.

20. The method of claim 6, wherein the most qualified job seekers selected in the first personality filtering process have one or more of a matching score above a predefined limit and constitute a predefined number of a highest matching score.

21. The method of claim 6, wherein the most qualified job seekers selected in the second personality validation process have one or more of a matching score above a first predefined limit and a validation score above a second predefined limit.

22. The method of claim 6, wherein the matching score is calculated by aggregating sub-scores from one or more or predefined or each group of job seeker attributes.

23. The method of claim 6, wherein a predefined weight factor is applied to the sub-score of one or more of the group of job seeker attributes.

24. A system for selecting most qualified job seekers for a job opening, the most qualified job seekers selected among a plurality of job seekers having a personal profile stored in a database, the job opening associated with a group of desired attributes, each personal profile associated with a group of job seeker attributes selected by a corresponding job seeker, said group of job seeker attributes at least comprising personality attributes, the system comprising:
a processing device component configured to:
complete a first personality filtering process comprising calculating a matching score for each job seeker for each job opening by matching the group of desired attributes of the job openings to the personal profiles of the job seekers and selecting the most qualified job seekers based on the matching score, and
complete a second personality validation process comprising generating a personality related questionnaire based on one or more of the job opening attributes, the questionnaire having a text based part, and a video based part, calculating a validation score for each answering job seeker for each job opening by matching the group of desired attributes of the job openings to the text based questionnaire answers from the job seekers, and selecting, by the processing device, one or more most preferred qualified job seekers based on the validation score;
input/output hardware configured to:
provide each of the qualified job seekers with said questionnaire, the text based part of the questionnaire having limited answering options, the video based part posing one or more questions to be answered by a video interview by the qualified job seekers, and
receive answers to the questionnaires from the qualified candidates; and
network interface hardware configured to:
complete a third confirmation process comprising transmitting the video interview of the one or more most preferred qualified job seekers to an employer.
